(19) United States
(12) Patent Application Publication
(10) Pub. No.: US 2014/0332264 A1
(43) Pub. Date: Nov. 13, 2014

(54) CABLE DEVICE

(71) Applicant: CyberPower Systems, Inc., Taipei City (TW)

(72) Inventors: Jian-Hung CHEN, Taipei City (TW); Chih-Ming CHEN, Taipei City (TW)

(73) Assignee: CyberPower Systems, Inc., Taipei City (TW)

(21) Appl. No.: 14/016,446

(22) Filed: Sep. 3, 2013

(30) Foreign Application Priority Data
May 13, 2013 (TW) 102116891

(51) Int. Cl. H01B 7/04

(52) U.S. Cl. CPC H01B 7/04
USPC 174/70 R

(57) ABSTRACT

A cable device includes a cable body having at least one prestressed portion for enabling the cable body to be arranged in the shape of a zigzag or circular winding, and a plurality of magnetic attraction devices fixedly mounted around the periphery of the cable body at two sides relative to one respective curved prestressed portion and so configured that each two adjacent magnetic attraction devices are fastenable to each other by magnetic attraction to keep the cable body in the shape of a zigzag or circular winding, preventing tangle or damage of wire, maintaining signal transmission stability, and facilitating easy repeated use and connection.

This application claims the priority benefit of Taiwan patent application number 102116891, filed on May 13, 2013.

### BACKGROUND OF THE INVENTION

1. Field of the Invention

The present invention relates to wire and cable technology, and more particularly to a cable device that can be conveniently arranged in a zigzag or circular winding form, preventing tangle or damage to wire, maintaining signal transmission stability, and facilitating easy repeated use and connection.

2. Description of the Related Art

With the progress of the times and improvement of the quality of people's lives, television, refrigerator, stereo system, washing machine, copy machine, fax machine, computer and many other advanced electrical and electronic appliances have been created and used in our daily lives at home or office to comfort people. An electrical or electronic apparatus generally comprises a power cable for connection to a city power outlet or power source means to obtain the necessary working power. Further, an electrical or electronic apparatus may be used with a signal line or extension cable. If an electrical or electronic apparatus is connected with multiple cables, these cables must be well organized. People may roll up or continuously bend the cables back and forth, and then use a rubber band or binding wire to fasten the cables in a received condition. However, the inner conducting wires of the cables can break easily when the cables are received in a zigzag or circular winding form. When wishing to extend out the cables, the user must unfasten the rubber band or binding wire, bringing inconvenience to the user.

Further, the cables of the display screen, keyboard, mouse, printer, scanner, fax machine of a computer system are disorderly left on the floor or table surface around the mainframe of the computer system, these cables can get tangled, or be hooked by an external object, causing an accident.

Therefore, there is a strong demand for cable device that eliminates the aforesaid problems.

### SUMMARY OF THE INVENTION

The present invention has been accomplished under the circumstances in view. It is therefore the main object of the present invention to provide a cable device, which can be arranged in a zigzag or circular winding form, preventing tangled or broken wire, maintaining signal transmission stability, and facilitating easy repeated use and connection.

To achieve this and other objects of the present invention, a cable device comprises a cable body having at least one prestressed portion for enabling the cable body to be arranged in a zigzag or circular winding form, and a plurality of magnetic attraction devices fixedly mounted around the periphery of the cable body at two sides relative to one respective curved prestressed portion and so configured that each two adjacent magnetic attraction devices are fastenable to each other by magnetic attraction.

Preferably, each magnetic attraction device comprises a base block fixedly mounted at the cable body, and at least one magnetic component bedded in the base block and having at least one magnetic attractive surface thereof exposed to the outside of the base block.

Preferably, the base block of each magnetic attraction device is so configured that, when the magnetic components of two adjacent magnetic attraction devices are secured together by magnetic attraction, the base blocks of these two magnetic attraction devices are abutted against each other to keep the two segments of the received cable body apart, preventing tangle or damage of wire, maintaining signal transmission stability, and facilitating easy repeated use.

### BRIEF DESCRIPTION OF THE DRAWINGS

FIG. 1 is an elevational view of a cable device in accordance with the present invention.

FIG. 2 is a schematic sectional view of the cable device in accordance with the first embodiment of the present invention.

FIG. 3 is an elevational view of a cable device in accordance with a second embodiment of the present invention.

FIG. 4 is a schematic sectional view of a cable device in accordance with a third embodiment of the present invention.

FIG. 5 is an elevational view of a part of a cable device in accordance with a fourth embodiment of the present invention.

FIG. 6 is a sectional view, in an enlarged scale, of a part of the cable device in accordance with the fourth embodiment of the present invention.

FIG. 7 is an elevational view of a cable device in accordance with a fifth embodiment of the present invention.

### DETAILED DESCRIPTION OF THE PREFERRED EMBODIMENT

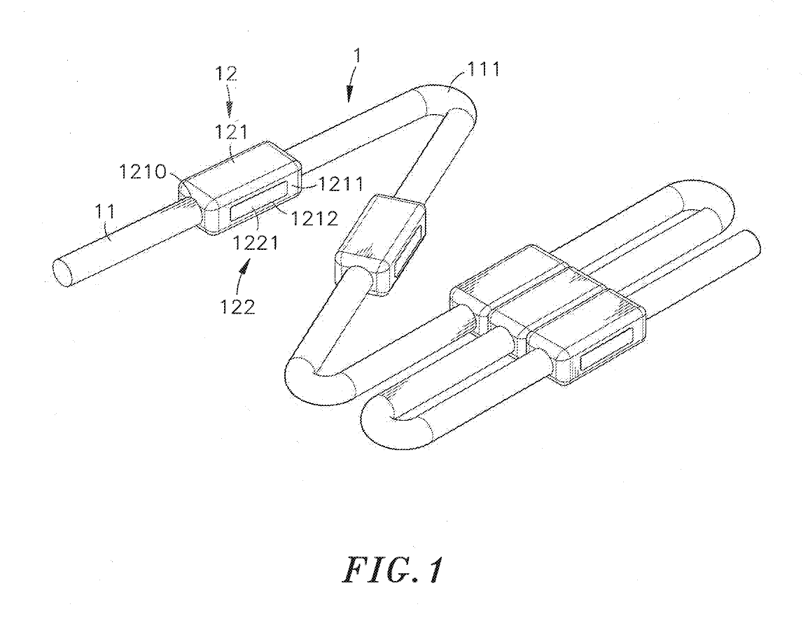

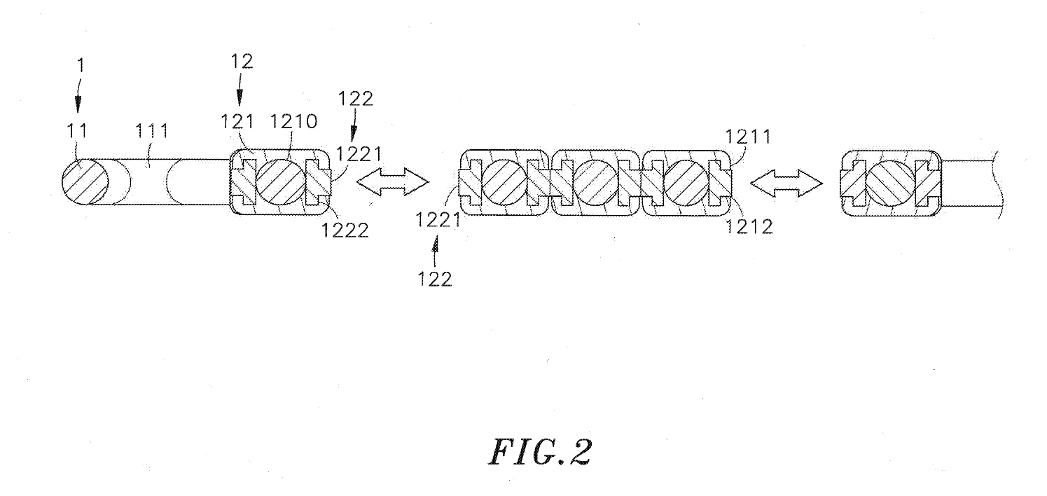

Referring to FIGS. 1 and 2, a cable device in accordance with a first embodiment of the present invention is shown, The cable device 1 comprises a cable body 11 defining at least one curved prestressed portion 111, and a plurality of magnetic attraction devices 12 fixedly mounted around the periphery of the cable body 11 at two sides relative to one respective curved. prestressed portion 111. Each magnetic attraction device 12 comprises a base block 121 fixedly mounted at the cable body 11, and at least one magnetic component 122 embedded in the base block 121 and having a magnetic attractive surface 1221 thereof exposed to the outside of the base block 121. In this embodiment, each magnetic component 122 is a magnet.

The magnetic component 122 is embedded in the base block 121 by insert molding. Further, the base block 121 can be affixed to the cable body 11 by insert molding. Alternatively, the base block 121 can be configured to provide an insertion hole 1210 extending through opposing front and rear ends thereof for the insertion of the cable body 11. Further, a bonding glue, adhesive resin, superglue, thermo-melting adhesive can be applied to bond the base block 121 and the cable body 11 together. Tongue-and-groove joint or any other fastening structure or technique can be employed to affix the base block 121 and the cable body 11 together. Further, the base block 121 comprises a locating portion 1212 defined in at least one of two opposite lateral sides 1211 thereof. The locating portion 1212 can be a groove or flange. Each magnetic component 122 comprises a stepped mounting portion 1222 fitting the locating portion 1212. Using insert molding to affix the magnetic component 122 to the base block 121 and the base block 121 to the cable body 11 simplifies the manufacturing process and reduces the manufacturing cost.

Further, the cable body 11 can be a power cable, transmission cable or electrical extension cable. When receiving the cable device 1, bending every curved prestressed portion 111 to arrange the cable device 1 in the shape of a zigzag or circular winding, enabling the magnetic surface 1221 of the magnetic component 122 at one side of the base block 121 of one magnetic attraction device 12 and the magnetic attractive surface 1221 of the magnetic component 122 at one side of the base block 121 of one adjacent magnetic attraction device 12 to be secured together by magnetic attraction subject to their reversed polarities. When the magnetic components 122 of two adjacent magnetic attraction devices 12 are secured together by magnetic attraction, the base blocks 121 of these two magnetic attraction devices 12 are abutted against each other to keep the two segments of the received cable body 11 apart, preventing tangled or broken wire, maintaining signal transmission stability, and facilitating easy repeated use and connection.

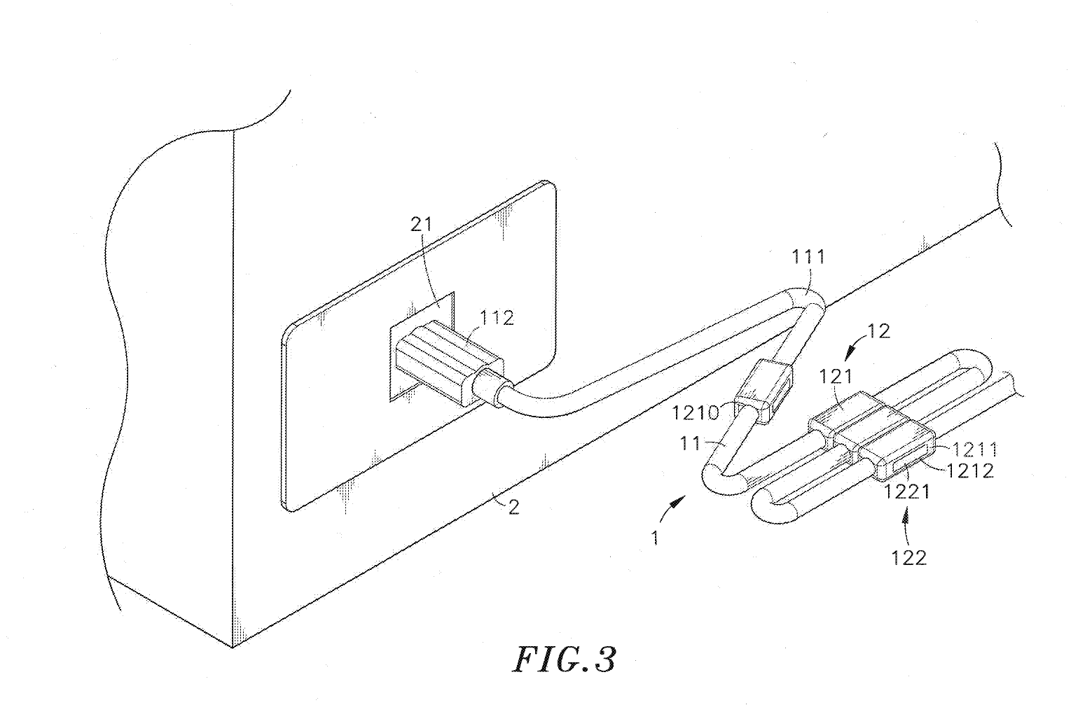

Referring to FIG. 3, a cable device 1 in accordance with a second embodiment of the present invention is shown. According to this second embodiment, the cable device 1 further comprises an electrical connector, for example, electrical plug (electrical power plug, audio plug, USB plug, HDMI plug, DVI plug, or RJ plug) 112 located at one end (or each of two opposite ends) of the cable body 11. After connection of the electrical plug 112 to an electrical socket 21 in a wall 2 or a mating electrical connector of an electronic apparatus, machine or electric power appliance (not shown), the cable body 11 of the cable device 1 can be properly arranged by securing the magnetic attraction devices 12 together by magnetic attraction and/or attaching the magnetic attraction devices 12 to a magnetically attractive metal panel at the wall 2 or the magnetically attractive metal of a screen, tale, rack, or any other furniture), preventing tangle of wire and keeping the surroundings neat and safe.

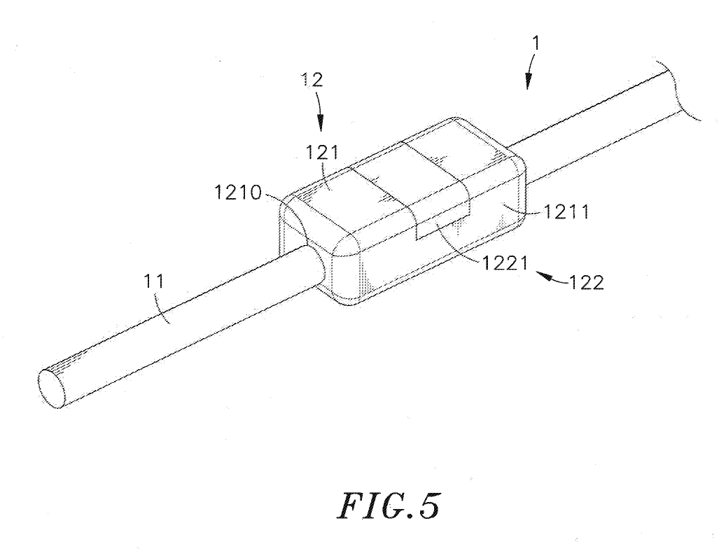

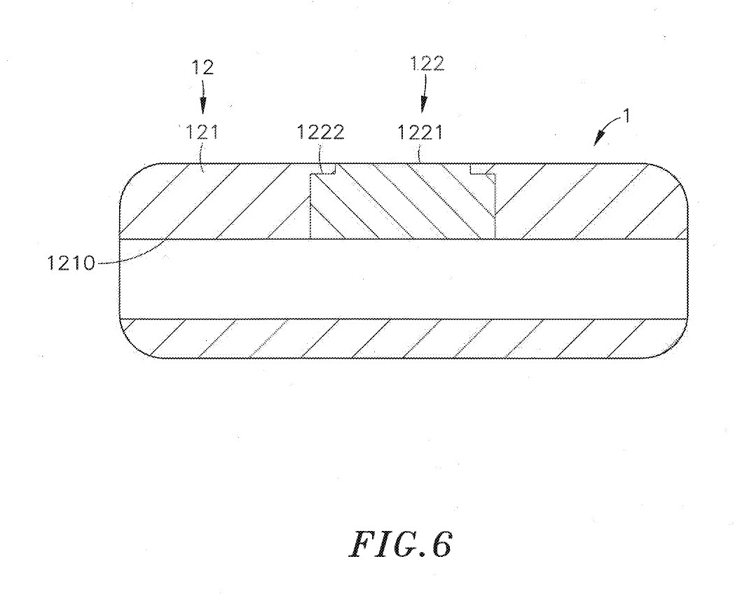

Referring to FIGS. 5 and 6, a cable device 1 in accordance with a fourth embodiment of the present invention is shown. This embodiment is substantially similar to the aforesaid first embodiment with the exception that the magnetic component 122 of each magnetic attraction device 12 is mounted at the top side of the base block 121, having two magnetic attractive surfaces 1221 of reversed polarities respectively extended to two opposite lateral sides 1211 of the base block 121 and so arranged such that one magnetic attractive surface 1221 of the magnetic component 122 of one magnetic attraction device 12 is magnetically attractive to one respective magnetic attractive surface 1221 of the magnetic component 122 of each adjacent magnetic attraction device 12.

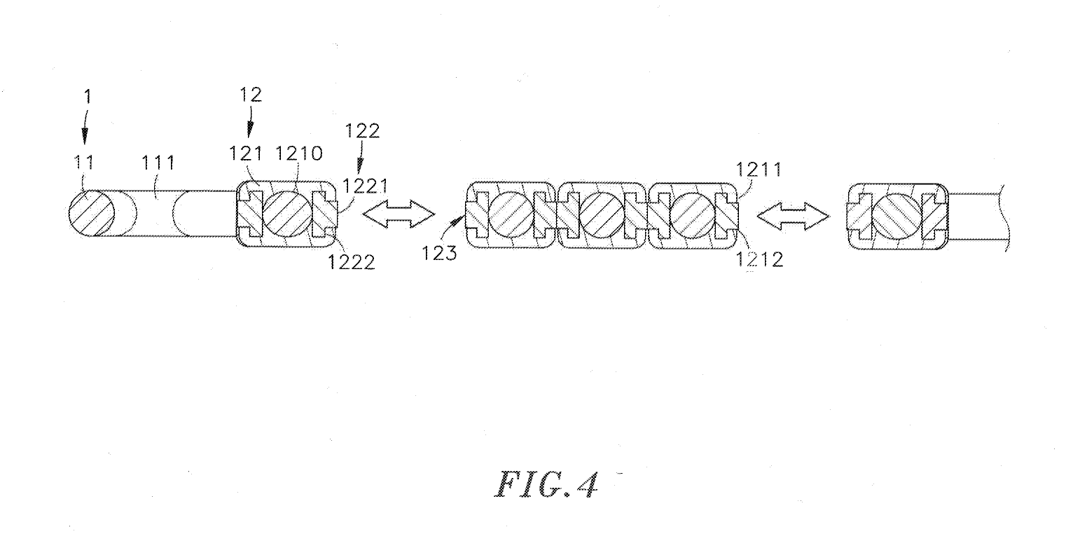

Referring to FIG. 4, a cable device 1 in accordance with a third embodiment of the present invention is shown. According to this third embodiment, each magnetic attraction device 12 comprises a base block 121 fixedly mounted at the cable body 11, a magnetic component 122 embedded in one lateral side of the base block 121 and having a magnetic attractive surface 1221 exposed to the outside of the base block 121, and a magnetically attractive metal component 123 selected from iron, cobalt, nickel or their alloys and embedded in the opposite lateral side of the base block 121. Thus, the magnetic component 122 (or magnetically attractive metal component 123) of one magnetic attraction device 12 is fastenable to the magnetically attractive metal component 123 (or magnetic component 122) of one adjacent magnetic attraction device 12 by magnetic attraction.

Further, in the aforesaid various embodiments, the diameter of the insertion hole 1210 of the base block 121 is configured subject to the diameter the cable body 11. By means of changing the diameter of the insertion hole 1210, the base block 121 can be installed in a different diameter of cable body 11.

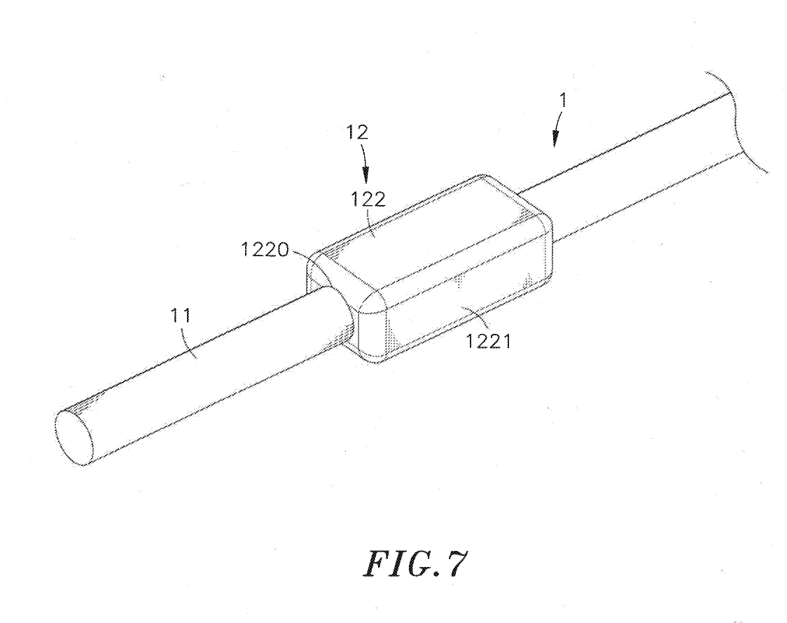

Referring to FIG. 7, a cable device 1 in accordance with a fifth embodiment of the present invention is shown. According to this fifth embodiment, each magnetic attraction device 12 is formed of a magnetic component 122 and fixedly mounted around the periphery of the cable body 11, comprising an insertion hole 1220 extending through opposing front and rear ends thereof for the insertion of the cable body 11, and two magnetic attractive surfaces 1221 of reversed polarities respectively disposed at two opposite lateral sides thereof. Thus, one magnetic attractive surface 1221 of one magnetic component 122 is fastenable to one mating magnetic attractive surface 1221 of one adjacent magnetic component 122 by magnetic attraction.

In conclusion, the invention provides a cable device 1, which comprises a cable body 11 having at least one prestressed portion 111, and a plurality of magnetic attraction devices 12 fixedly mounted around the periphery of the cable body 11 at two sides relative to one respective curved prestressed portion 111 and so configured that each two adjacent magnetic attraction devices 12 are fastenable to each other by magnetic attraction to keep the cable body 11 in the shape of a zigzag or circular winding, preventing tangled or broken wire, maintaining signal transmission stability, and facilitating easy repeated use and connection.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A cable device, comprising:
a cable body having at least one prestressed portion for enabling the cable body to be arranged in a zigzag or circular winding form; and
a plurality of magnetic attraction devices fixedly mounted around the periphery of said cable body at two sides relative to each said curved prestressed portion and so configured that each two adjacent said magnetic attraction devices are fastenable to each other by magnetic attraction.

2. The cable device as claimed in claim 1, wherein each said magnetic attraction device comprises a base block fixedly mounted at said cable body, and at least one magnetic component embedded in said base block, each said Magnetic component having at least one magnetic attractive surface thereof exposed to the outside of said base block.

3. The cable device as claimed in claim 2, wherein said base block comprises a locating portion defined in at least one of two opposite lateral sides thereof; each said magnetic component comprises a stepped mounting portion fitting said locating portion.

4. The cable device as claimed in claim 2, wherein said base block is fixedly mounted at said cable body by insert molding.

5. The cable device as claimed in claim 2, wherein said base block comprises an insertion hole extending through opposing front and rear ends thereof for the passing of said cable body.

6. The cable device as claimed in claim 2, wherein each said magnetic attraction device comprises one single said magnetic component embedded in said base block, the single magnetic component of each said magnetic attraction device having two magnetic attractive surfaces of reversed polarities respectively disposed at two opposite lateral sides of said base block.

7. The cable device as claimed in claim 2, wherein each said magnetic attraction device comprises two said magnetic components embedded in two opposite lateral sides of said base block, each said magnetic component comprising a magnetic attractive surface exposed to the outside of said base block, the magnetic attractive surfaces of the two magnetic components of each said magnetic attraction device providing reversed polarities.

8. The cable device as claimed in claim 1, wherein each said magnetic attraction device comprises a base block fixedly mounted at said cable body, a magnetic component embedded in one lateral side of said base block, and a magnetically attractive metal component selected from the material group of iron, cobalt, nickel and their alloys and embedded in an opposite lateral side of said base block so that the magnetic component of one said magnetic attraction device is fastenable to the magnetically attractive metal component of one adjacent said magnetic attraction device by magnetic attraction.

9. The cable device as claimed in claim 2, wherein each said magnetic component is a magnet.

10. The cable device as claimed in claim 1, wherein each said magnetic attraction device is formed of a magnetic component and fixedly mounted around the periphery of said cable body, said magnetic component comprising an insertion hole extending through opposing front and rear ends thereof for the passing of said cable body and two magnetic attractive surfaces of reversed polarities respectively disposed at two opposite lateral sides thereof.
